(19) United States
(12) Patent Application Publication
(10) Pub. No.: US 2017/0280878 A1
(43) Pub. Date: Oct. 5, 2017

(54) SUN SHADE FOR CAR SEATS

(71) Applicant: Allen Deiotte Hill, Calabasas, CA (US)

(72) Inventor: Allen Deiotte Hill, Calabasas, CA (US)

(21) Appl. No.: 15/475,060

(22) Filed: Mar. 30, 2017

Related U.S. Application Data
(60) Provisional application No. 62/315,399, filed on Mar. 30, 2016.

(51) Int. Cl. A47C 7/66; B60N 2/26

(52) U.S. Cl. CPC A47C 7/66; B60N 2/26

(57) ABSTRACT

A car seat sun shade is provided. The car seat sun shade includes a top flap dimensioned to extend over the length of a car seat. Opposing ends of the car seat sun shade provide adjustable straps for extending around and removably connecting about a rear and front headrest, respectively, keeping the top flap adjacent to and spaced apart from a child in the car seat disposed between the rear and front headrests. The top flap provides side flaps draping from the top flap to a location below the head of the child, the side flaps being movable between the draped condition and a folded condition for making the child visible to a user.

### CROSS-REFERENCE TO RELATED APPLICATION

This application claims the benefit of priority of U.S. provisional application No. 62/315,399, filed 30 Mar. 2016, the contents of which are herein incorporated by reference.

### BACKGROUND OF THE INVENTION

The present invention relates to childcare accessories and, more particularly, a sun shade for child and infant car seats.

Parents with children in car seats have typically experienced challenges with keeping the direct sunlight out of the child's eyes while in a vehicle. Infant car seats sometimes include a built-in canopy to shade some of the sunlight from the side windows, but not sunlight from the back window when the infant seat is rear facing. Additionally, these canopies are not compatible with convertible or all in one car seats, which do not include sun shades.

Current sun shades include canopy and window shade types. Window shades adapted to block sunlight through attaching to a window have two detracting features: 1) the window shade inhibits the window from being rolled down; and 2) the window shade does not cover the entire window, allowing sunlight to shine in the baby's eyes. Canopies are typically adapted to attach to the handle of an infant car seat, engendering the following disadvantages: 1) it only works on infant car seats; 2) the canopy blocks the ability for the driver to see the baby; and 3) the canopy does not stay in position if the windows are down.

As can be seen, there is a need for a sun shade providing a shade structure for a child in an infant, convertible, or all in one car seats by attaching to the adjacent front and back headrest in the car, thereby extending at least the length of the associated car seat. The sun shade provides adjustable side flaps to ensure sunlight stays off of the baby's face, while being movable so as to provide a clear view of the baby's face when desired.

### SUMMARY OF THE INVENTION

In one aspect of the present invention, a sun shade apparatus for a child car seat providing a top flap extending from a first end to an opposing second end, wherein the top flap is dimensioned to extend approximately a length of the child car seat; two spaced apart straps extending from each of said ends, each of the two spaced apart straps having a connector removably connectable to each other; and a side flap extending from each side of the top flap so as to be movable between a draped and a folded condition, wherein the draped condition of each side flap extends from an upper portion of the car seat to a lower portion thereof.

In another aspect of the present invention, a system providing a shade structure over a child car seat provides a vehicle having a front and a rear headrest on opposing sides, respectively, of the child car seat secured therebetween; and a sun shade apparatus having a top flap extending from a first end to an opposing second end, wherein the top flap is dimensioned to extend approximately a length of the child car seat; two spaced apart straps extending from each of said ends, each of the two spaced apart straps having a connector removably connectable to each other, wherein each two spaced apart straps wrap around an adjacent headrest of the front and rear headrests; and a side flap extending from each side of the top flap so as to be movable between a draped and a folded condition, wherein the draped condition of each side flap extends from an upper portion of the car seat to a lower portion thereof, wherein each headset provides two spaced apart posts, and wherein each two spaced apart straps wrap around each respective two spaced apart posts, and wherein certain embodiments, sidewalls provided by the child car seat are adapted to extend above a head of a human child secured within the child car seat, and wherein the top flap engages a top portion of the sidewalls as it extends between the front and rear headrests, wherein the side flaps are adapted and dimensioned to extend in the draped condition below said head, and wherein at least one connector is adapted to adjust a length of a respective strap of each two spaced apart straps for selectively connecting the top flap between the front and rear headrests.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention with a side flap 14 folded back, providing visibility of a child in a car seat;

FIG. 2 is a perspective view of an exemplary embodiment of the present invention;

FIG. 3 is a cutaway side view of an exemplary embodiment of the present invention installed in a vehicle over a car seat; and

FIG. 4 is a top schematic view of an installed exemplary embodiment of the present invention with headrests 24 and 28 shown as hidden for clarity.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention includes a car seat sun shade providing a top flap dimensioned to extend over the length of a car seat. Opposing ends of the car seat sun shade provide adjustable straps for extending around and removably connecting about a rear and front headrest, respectively, keeping the top flap adjacent to and spaced apart from a child in the car seat disposed between the rear and front headrests. The top flap provides side flaps draping from the top flap to a location below the head of the child, the side flaps being movable between the draped condition and a folded condition for making the child visible to a user.

It should be understood by those skilled in the art that the use of directional terms such as upper, lower, upward, downwardly, top and the like are used in relation to the illustrative embodiments as they are depicted in the figures, the upward direction (or upper) being toward the top of the corresponding figures and a downward direction being toward the bottom of the corresponding figure.

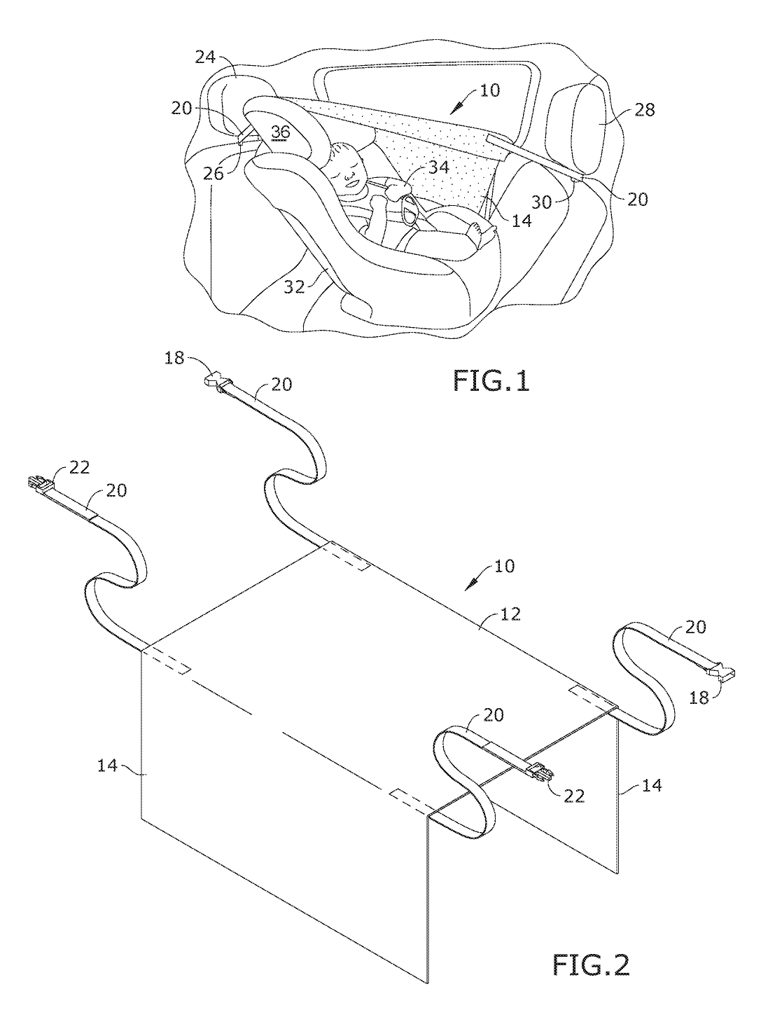

Referring to FIGS. 1 through 4, the present invention provides a car seat sun shade 10. The car seat sun shade 10 has a top flap 12 made of a sufficiently strong and pliable material, such as cotton fabric, synthetic fabric or the like. The top flap 12 may be generally rectangular extending from a first end to a second end along a longitudinal axis, though the top flap 12 may be any shape suitable for the purposes disclosed herein.

A side flap 14 may be attached along each of the opposing side edges of the top flap 12. In certain embodiments, the side flaps 14 may be extensions of the top flap 12.

Extending from each end, two spaced apart adjustable straps 20 may terminate in male and female connectors 22 and 18, respectively. The male and female connectors 22 and 18 may be clasps, buckles, or the like, wherein the male or female connectors 22 or 18 are adapted to selectively adjust the effective length of their respective strap 20. The male and female connectors 22 and 18 are adapted to removably connect to each other.

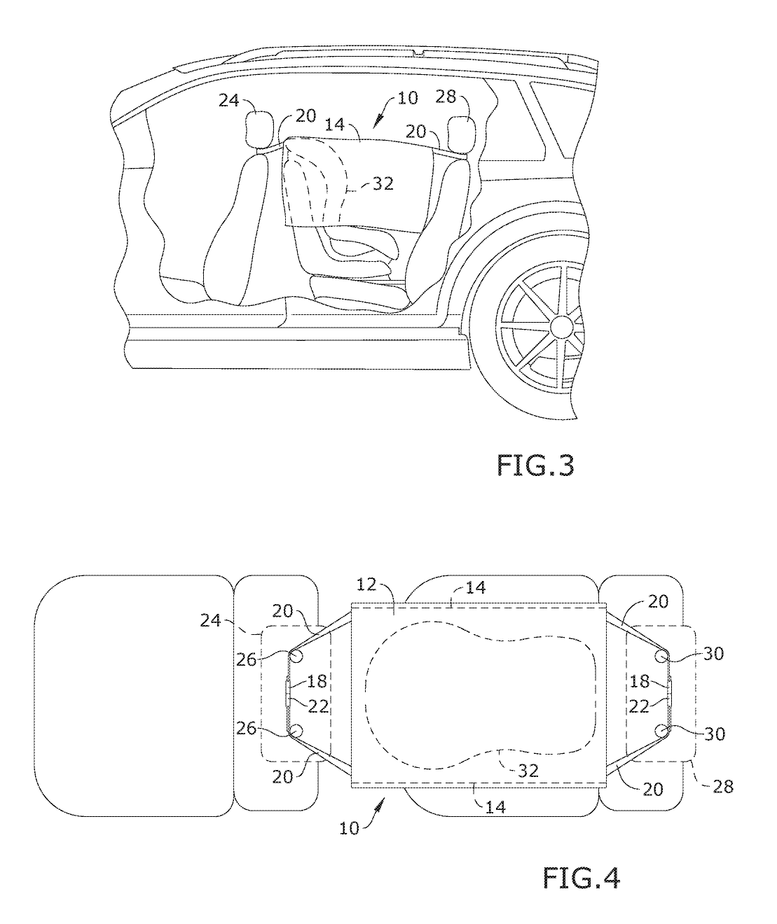

A method of using the present invention may include the following. The car seat sun shade 10 disclosed above may be provided. A car seat 34 may provide sidewalls 36 that extend above a head of the secured child 34. After installing the car seat 34 in a vehicle, a user may extend the adjustable straps 20 associated with the first side of the top flap 12 around opposing sides of a front headrest 24 (and/or the posts 26 thereof) of the vehicle so as to connect the male and female connectors 22 and 18. Then the user may then extend the adjustable straps 20 associated with the second side of the top flap 12 around opposing sides of a rear headrest 28 (and/or the posts 30 thereof) of the vehicle so as to connect the male and female connectors 22 and 18, whereby the top flap 12 extends adjacent to the car seat 32 but spaced apart from the child 34. The top flap 12 provides a shade structure over the car seat 32, wherein the side flaps 14 are dimensioned and adapted to drape from the top flap 12 to a position lower than a head of the secured child 34, as illustrated in FIG. 3. The user can easily lift and fold a side flap 14 from a draped condition to a folded condition onto the top flap 12, enabling viewing the child face directly or through a rearview mirror, as illustrated in FIG. 1.

The secured adjustable straps 20 hold the top flap 12 in place when attached to the front and back headrests 24 and 28 in the vehicle, thereby preventing the (possibly taut) car seat sun shade 10 from shifting or moving when a nearby window is open or even when the vehicle is a convertible. The car seat sun shade 10 is dimensioned and adapted to provide full coverage from the sunlight, as well as making it compatible with infant, convertible, and all in one car seats.

It should be understood, of course, that the foregoing relates to exemplary embodiments of the invention and that modifications may be made without departing from the spirit and scope of the present invention.

What is claimed is:

1. A sun shade apparatus for a child car seat, comprising:
a top flap extending from a first end to an opposing second end, wherein the top flap is dimensioned to extend approximately a length of the child car seat;
two spaced apart straps extending from each of said ends, each of the two spaced apart straps having a connector removably connectable to each other; and
a side flap extending from each side of the top flap so as to be movable between a draped and a folded condition, wherein the draped condition of each side flap extends from an upper portion of the car seat to a lower portion thereof.

2. The sun shade of claim 1, wherein at least one connector is adapted to adjust a length of a respective strap of each two spaced apart straps.

3. A system for providing a shade structure over a child car seat, comprising:
a vehicle having a front and a rear headrest on opposing sides, respectively, of the child car seat secured therebetween; and
a sun shade apparatus providing:
a top flap extending from a first end to an opposing second end, wherein the top flap is dimensioned to extend approximately a length of the child car seat;
two spaced apart straps extending from each of said ends, each of the two spaced apart straps having a connector removably connectable to each other, wherein each two spaced apart straps wrap around an adjacent headrest of the front and rear headrests; and
a side flap extending from each side of the top flap so as to be movable between a draped and a folded condition, wherein the draped condition of each side flap extends from an upper portion of the car seat to a lower portion thereof.

4. The system of claim 3, wherein each headset provides two spaced apart posts, and wherein each two spaced apart straps wrap around each respective two spaced apart posts.

5. The system of claim 3, further comprising sidewalls provided by the child car seat, wherein the sidewalls are adapted to extend above a head of a human child secured within the child car seat, and wherein the top flap engages a top portion of the sidewalls as it extends between the front and rear headrests.

6. The system of claim 5, wherein the side flaps are adapted and dimensioned to extend in the draped condition below said head.

7. The system of claim 3, wherein at least one connector is adapted to adjust a length of a respective strap of each two spaced apart straps for selectively connecting the top flap between the front and rear headrests.
